(19) United States
(12) Patent Application Publication
(10) Pub. No.: US 2022/0236104 A1
(43) Pub. Date: Jul. 28, 2022

(54) A MACHINE TEST MECHANISM

(71) Applicant: TUSAS- TURK HAVACILIK VE UZAY SANAYII ANONIM SIRKETI, Ankara (TR)

(72) Inventors: Cenk OZDEMIR, Kahramankazan, Ankara (TR); Alper Bahri AKER, Kahramankazan, Ankara (TR)

(73) Assignee: TUSAS- TURK HAVACILIK VE UZAY SANAYII ANONIM SIRKETI, Ankara (TR)

(21) Appl. No.: 17/626,413

(22) PCT Filed: Aug. 24, 2020
(86) PCT No.: PCT/TR2020/050748

§ 371 Date: Jan. 11, 2022

(30) Foreign Application Priority Data
Aug. 28, 2019 (TR) 2019/13066

(51) Int. Cl. G01H 1/00; G01M 13/00; G08B 21/18

(52) U.S. Cl. CPC G01H 1/00; G08B 21/187; G01M 13/00

(57) ABSTRACT

The present invention relates to a test mechanism (1) which comprises a machine (2); at least one sensor (3) which is located on the machine (2) and enables data to be received from physical environment; a computer unit (4) which enables data received by the sensor (3) to be collected and stored; a control unit (5) which is located in the computer unit (4), processes data and decides whether the machine (2) operates normally or in an unsafe condition; and a safety module (6) which stops the machine (2) and/or alerts operator in an unsafe condition according to data received from the control unit (5).

The present invention relates to a machine test mechanism which stops the machine and/or alerts an operator in case of an unsafe condition during a machine test process.

Machines must be tested before they are integrated into a system in order to ensure safe operational conditions under mechanical load. In case that a malfunction occurs in machines operated at high speed under mechanical load, there is a risk of serious injury for the test operator and damage to the environment of the machine. Said test systems are stopped by the test operator or automatically if the machine does not operate properly.

In U.S. Pat. No. 6,370,957, which is included in the known state of the art, vibration analyzes are performed for operational conditions of rotating machines. When rotary machine operates in smooth-running conditions, basic data is collected throughout a learning mode. Initial vibration values are collected, averaged and analysed throughout the learning mode. Therefore, threshold values are calculated to determine Run/Stop conditions. With an operation mode, data is measured over the machine, compared with threshold values obtained by the learning mode, the Run/Stop condition is provided accordingly, and operational parameters of the machine are obtained. However, prevention of an unsafe condition under different conditions is not disclosed for this system.

Another patent document no. US2019064034A1 discloses a vibrational sensing system and an operation method thereof. Said system comprises an accelerometer and a data processor. Said data processor determines the on/off state of a motor according to the data collected by said accelerometer. According to this document, data collected by accelerometer is used for determining an alarm threshold. In order to determine said threshold, data collected only during the on state of the motor is used.

Another patent document no. EP3413027A1 discloses a complex machine tool having failure predication function. According to this document, by using the frequency of the vibrations received from a sensor, failure situation is determined.

Another patent document no. WO2018119489A1 discloses a monitoring system for monitoring a machine. Said system comprises a monitoring device, having a housing; a coupling that physically attaches the housing to the machine; a plurality of sensors comprising a vibration sensor that senses vibration transmitted from the machine to the vibration sensor at least in part via the coupling; a monitoring device processor that acquires sensors signals from the plurality of sensors and generates sensor data at least partially in accordance with signals from the sensors; and a transmitter that transmits the sensor data.

The test mechanism according to the present invention can be implemented in various machine types without requiring additional equipment, machines can be operated at their threshold values such that they prevent work safety vulnerabilities, and thus, there is obtained a test mechanism which can be controlled instantaneously in an effective manner.

The test mechanism realized to achieve the object of the invention and defined in the first claim and the other claims dependent thereon comprises a machine; at least one sensor which is located on the machine and enables data to be received from physical environment; a computer unit which enables the data received by the sensor to be collected and stored; and a control unit located in the computer unit. The control unit receives and processes data from the computer unit in real time, and determines whether the machine operates normally or in an unsafe condition. The system comprises a safety module which stops the machine and/or alerts operator in an unsafe condition according to data received from the control unit.

The test mechanism according to the invention comprises a control unit which performs the steps of:
applying a mathematical process on the data measured by the sensor from physical environment;
obtaining an average value with the data, on which mathematical process is applied, within the time determined by a user in learning mode application, and determining said value as a machine characteristic;
inputting a reference value by the user via an interface provided in the computer unit by taking into account the machine characteristic value, which is obtained as a result of learning mode, in order to initiate a process for testing the machine;
switching to an operation mode when the learning mode is completed, and receiving the data, on which mathematical process is applied, as machine data in the operation mode;
comparing the reference value input by the user via the interface with the machine data obtained by the operation mode, and deciding whether the machine is operating normally or in an unsafe condition according to the data obtained as a result of comparison.

In an embodiment of the invention, in the test mechanism, a data set is created with the data obtained by the sensor within the time period determined by the user, a sub-data set is created from the data set elements, and average of the data set and the sub-data set are compared to each other. These processes are used by the control unit as a mathematical process application.

In an embodiment of the invention, in the test mechanism, a data set is created by performing random sampling, in a number determined by the user, from the data obtained by the sensor from the machine; a sub-data set is created by taking the last sampling data in the number determined by the user from the data in the data set; the data set is averaged and this average is assigned as a data set average; the sub-data set is averaged and this average is assigned as a sub-data set average; data set average and sub-data set average are compared to each other and a total average value is obtained. By using as a mathematical process application, a total average value is obtained within a time period determined by the user, and such a value is determined in the control unit as a machine characteristic.

In an embodiment of the invention, the test mechanism comprises a control unit which receives the total average values obtained in the operation mode as machine data by applying a mathematical process on each data, which are obtained after the learning mode, within a period determined by the user.

In an embodiment of the invention, the test mechanism comprises a control unit which uses any of the FFT (Fast Fourier Transform), RMS (Root Mean Square), HFE (High Frequency Enveloping), KU (Kurtosis) and CF (Crest Factor) analysis methods, which are applied to the data obtained by the sensor from physical environment, as a mathematical process application.

In an embodiment of the invention, the test mechanism comprises a data collection device which is provided in the computer unit and collects data received by the sensor, wherein types of data collection device with different sampling frequencies can be used.

In an embodiment of the invention, the test mechanism comprises a memory which is provided in the computer unit, and enables data received by the sensor to be stored in each stage of the test process so that the data can be used later or information can be displayed when requested.

In an embodiment of the invention, the test mechanism comprises a display which is provided in the computer unit and displays the interface enabling the machine characteristic to be displayed by the user and the test to be initiated by inputting a reference value by the user.

In an embodiment of the invention, the test mechanism enables the control unit to automatically switch from the learning mode to the operation mode after the time determined by the user has elapsed.

In an embodiment of the invention, the test mechanism comprises an interface which accepts the value obtained by the learning mode as a reference value when the machine characteristic is learned but no data is entered as a result of the learning mode by the user.

In an embodiment of the invention, the test mechanism comprises a safety module which provides an aural and/or visual warning for informing the operator in case of an unsafe condition.

In an embodiment of the invention, the test mechanism comprises a safety module which stops the test when it is decided that the machine operates in an unsafe condition according to data received as a result of continuous comparison, in the control unit, of the reference value input to the interface with the machine values obtained periodically as a result of the operation mode.

In an embodiment of the invention, the test mechanism comprises a computer unit which converts data received by the sensor from physical environment from analogue signal into digital by sampling.

In an embodiment of the invention, the test mechanism comprises at least one sensor which is able to measure at least one of vibration, temperature, pressure, distance and angular velocity parameters.

Exemplary embodiments of the test mechanism according to the present invention are illustrated in the attached drawings, in which:

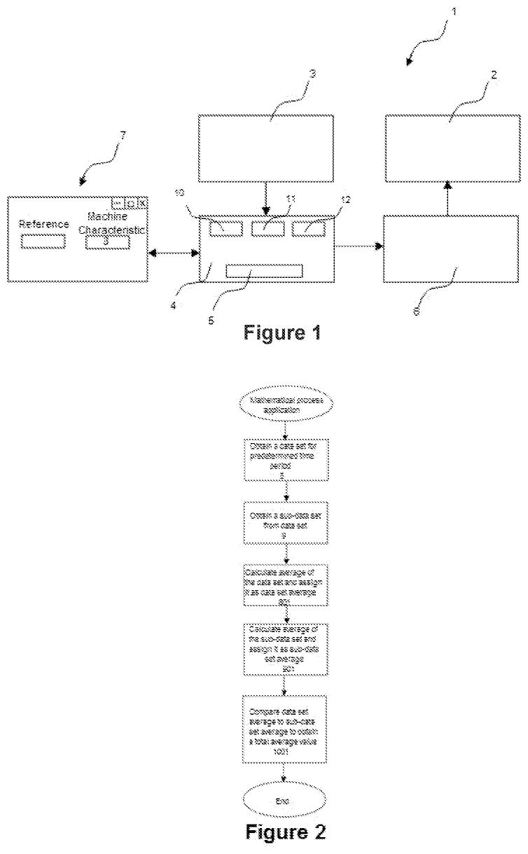

FIG. 1 is a block diagram of a test mechanism.

FIG. 2 is a mathematical process application algorithm of a test mechanism.

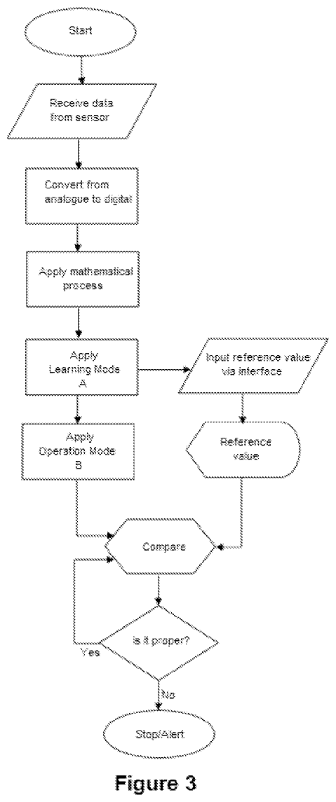

FIG. 3 is an algorithm of a test mechanism provided in the control unit thereof.

All the parts illustrated in figures are individually assigned a reference numeral and the corresponding terms of these numbers are listed below:
1. Machine Test Mechanism
2. Machine
3. Sensor
4. Computer Unit
5. Control Unit
6. Safety Module
7. Interface
8. Data set
9. Sub-data set
   801. Data set Average
   901. Sub-data set Average
   1001. Total Average Value
10. Data Collection Device
11. Memory
12. Display
   A. Learning mode
   B. Operation mode
   (K) User

The machine test mechanism (1) comprises a machine (2); at least one sensor (3) which is located on the machine (2) and enables data to be received from physical environment; a computer unit (4) which enables data received by the sensor (3) to be collected and stored; a control unit (5) which is located in the computer unit (4), processes data and decides whether the machine (2) operates normally or in an unsafe condition; and a safety module (6) which stops the machine (2) and/or alerts operator in an unsafe condition according to data received from the control unit (5).

The machine test mechanism (1) of the invention comprises a control unit (5) which performs the steps of:
applying a mathematical process on the data obtained by the sensor (3);
obtaining an average value with the data, on which mathematical process is applied, within the time period determined by a user (K) by the learning mode (A) algorithm, and accepting said value as a machine (2) characteristic;
inputting a reference value by the user (K) via an interface (7) provided in the computer unit (4) according to the machine (2) characteristic value which is obtained as a result of the learning mode (A) in order to initiate machine (2) test process;
after the learning mode (A) algorithm is completed, accepting the data, on which mathematical process is applied, as data of the operating machine (2) by the operation mode (B) algorithm;
comparing the reference value input via the interface (7) with the values obtained as a result of the operation mode (B), and deciding whether the machine (2) is operating normally or in an unsafe condition according to the data received from the control unit (5) as a result of the comparison (FIG. 1).

It is desired to test the machine (2) without damaging its environment and its own system. Data is received by the sensor (3) located on the tested machine (2) from physical environment, and collected in the computer unit (4). The computer unit (4) used for data collection is selected according to capacity and resolution meeting the requirements. Collected data is processed in the control unit (5) instantaneously and the results are stored in the computer unit (4); the data is stored temporarily as it is used instantaneously or the data obtained by the sensor (3) is stored in the computer unit (4) for later use. The control unit (5) located in the computer unit (4) provides for deciding whether the machine (2) works normally or in an unsafe condition by processing the data. According to the decision by the control unit (5), the safety module (6) stops the machine (2) that is in an unsafe condition and/or the alerts the operator. Therefore, when the machine (2) operates out of its nominal operating value, it is enabled that the machine (2) is stopped by the test operator or automatically and the possible accidents are prevented.

Data is obtained by the sensor (3) and collected in the computer unit (4). A mathematical process is applied on the collected data in the control unit (5). Object of this application is to be able to quickly detect the change in the data received from the machine. Since the machine test mechanism (1) performs learning in real time with data of the tested machine (2), it can be used in various systems without requiring additional equipment. The learning mode (A) that is run in the control unit (5) is obtaining an average value with data, on which mathematical process is applied, within the time period determined by the user (K), and taking this average value as the machine (2) characteristic. The reference value required to initiate the machine (2) test process is a value input by the user to the interface (7) according to the machine (2) characteristic value that is obtained as a result of the learning mode (A). The interface (7) is located in the control unit (5). If the tested machine (2) is in a mechanism while selecting the determined reference value by inputting a value to the interface (7), the mechanism is prevented from being damaged by the input reference value. However, if the machine (2) is desired to be forced with a test under load, the machine (2) can be operated safely at the limit values with the input reference value. After the time determined by the user (K) has elapsed, the learning mode (A) is automatically left. After the learning mode (A) is completed, the operation mode (B) is initiated. In the operation mode (B) run in the control unit (5), the data, on which mathematical process is applied, is operational data of the machine (2), i.e. mathematical process is applied on each data that are obtained until the machine (2) stops operating, and each data received after determining the machine (2) characteristic by the learning mode (A) becomes operational data of the machine (2) in the operation mode (B). Comparison of the reference value input to the interface (7) with the machine (2) data obtained as a result of the operation mode (B) continues throughout the test in the control unit (5). If the machine (2) data is at the desired level according to the data received as a result of the comparison, it is decided that the machine (2) operates normally and the test continues, and if operational data of the machine (2) is not at the desired level according to the reference value, it is decided that the machine (2) operates in an unsafe condition and the test is ended (FIG. 3).

In an embodiment of the invention, the machine test mechanism (1) comprises a control unit (5) which creates a data set (8) with the data obtained by the sensor (3) within the time period determined by the user (K), creates a sub-data set (9) from the data set, and compares the average of the data set (8) to the average of the sub-data set (9) and uses that as a mathematical process application. A data set (8) is created by determining a time period by the user (K). A sub-data set (9) is created from the data set (8). Average of the data set (8) and the sub data set (9) is calculated and compared to each other, and this ratio is used in the learning mode and the operation mode. Mathematical process is applied on the obtained data in the control unit (5). When the data with abnormal levels starts to be obtained in case the machine (2) malfunctions during the operation mode (B), the data set (8) changes slowly and the sub-data set (9) changes rapidly. Therefore, ratio of the average of the data set (8) and the average of the sub-data set (9) relative to each other rapidly changes, and the test is stopped by the safety module (6) and/or the operator is alerted in case of an unsafe condition.

In an embodiment of the invention, the machine test mechanism (1) comprises a control unit (5) which creates a data set (8) by performing random sampling, in a number determined by the user (K), from the data obtained by the sensor (3), creates a sub-data set (9) by taking the last sampling data, in the number determined by the user (K), from the data set, calculates the average of the data set (8) and assigns this as a data set average (801), calculates the average of the sub-data set (9) and assigns this as a sub-data set average (901), obtains a total average value (1001) by comparing the data set average (801) and the sub-data set average (901), and enables machine (2) characteristic to be determined by using the total average value (1001) as the mathematical process application. A data set (8) is created by performing random sampling, in a number determined by the user (K), from the data obtained by the sensor (3). A sub-data set (9) is created by taking the last sampling data, in the number determined by the user (K), from the random samplings in the data set (8). An average of the random samplings in the data set (8) is calculated and this average is assigned as a data set average (801). Average of the sub-data set (9) is calculated and this average is assigned as a sub-data set average (901). Data set average (801) and sub-data set average (901) are compared to each other and a total average value (1001) is obtained. For example, when the time determined by the user (K) to obtain the data set (8) is 1 second, the total average value (1001) is obtained every 1 second. These processes are used in the control unit (5) as a mathematical process application on the data obtained during the machine (2) test, and the machine (2) characteristic is enabled to be determined (FIG. 2).

In an embodiment of the invention, the machine test mechanism (1) comprises a control unit (5) which uses the total average value (1001) obtained with the mathematical process application to determine machine (2) data obtained by the operation mode (B). After the machine (2) characteristic is determined in the control unit (5) by the learning mode (A), total average values (1001) are obtained by applying mathematical process on the data continuously read from the machine (2), and these total average values (1001) are the machine (2) data obtained by operation mode (B). Machine (2) data is used in the process of comparison with the reference value in order to control the machine (2).

In an embodiment of the invention, the machine test mechanism (1) comprises a control unit (5) which applies any of the FFT (Fast Fourier Transform), RMS (Root Mean Square), HFE (High Frequency Enveloping), KU (Kurtosis) and CF (Crest Factor) analysis methods on the data obtained by the sensor (3) and uses that as a mathematical process application. Therefore, information about the mechanical state of the machine (2) is obtained.

In the FFT analysis method, the collected vibration data passes from the time domain to the frequency domain and the mixed signal curves are separated to analyse frequency and intensity of the vibration.

The RMS analysis method is the square root of the average of the squares of the signal values taken in a determined time interval.

In the HFE analysis method, the relationship of error frequencies with amplitude modulation/demodulation is explained.

The KU analysis method is a measure of the skewness and kurtosis of the graphed signals. This value increases due to the peak values occurring with a sudden rise.

In the CF analysis method, the maximum peak value is compared to the RMS value and reflects the magnitude of the error.

In an embodiment of the invention, the machine test mechanism (1) comprises a data collection device (10) which is provided in the computer unit (4) and enables the data received by the sensor (3) to be collected. The data collection device (10) is selected such that it can perform sampling at the desired resolution and speed according to the system requirements.

In an embodiment of the invention, the machine test mechanism (1) comprises a memory (11) which is provided in the computer unit (4), and enables data received by the sensor (3) to be stored. The memory (11) can store data in one or more stages of saving the data for later use, saving the data after applying the mathematical process, saving the data after obtaining the machine (2) characteristic by the learning mode (A), and saving the comparison results.

In an embodiment of the invention, the machine test mechanism (1) comprises a display (12) which is provided in the computer unit (4), and enables the user (K) to display the interface (7) to which the reference value is input in order to initiate the test process. The display (12) enables the user (K) to display the machine (2) characteristic and to input a reference value to the interface (7).

In an embodiment of the invention, the machine test mechanism (1) comprises a control unit (5) which allows for automatic switch from the learning mode (A) to the operation mode (B) after the time determined by the user (K) is completed. Therefore, the test process continues without the need for re-operation of the control unit (5) by the user (K).

In an embodiment of the invention, the machine test mechanism (1) comprises an interface (7) which accepts the value obtained by the learning mode (A) as a reference value when no data is input as a result of the learning mode (A) by the user (K). The user (K) inputs a reference value to the interface (7) according to the machine (2) characteristic obtained as a result of the learning mode (A). When no data is input to the interface (7), value obtained by the learning mode (A) is automatically input to the interface (7) as the reference value, thus the test process can be initiated automatically.

In an embodiment of the invention, the machine test mechanism (1) comprises a safety module (6) which provides an aural and/or visual warning in case of an unsafe condition. Work safety is achieved by providing an aural and/or visual warning by the safety module (6).

In an embodiment of the invention, the machine test mechanism (1) comprises a safety module (6) which enables the test to be stopped instantaneously when it is decided that the machine (2) operates in an unsafe condition according to data received from the control unit (5) as a result of comparison of the reference value input to the interface (7) with the values obtained as a result of the operation mode (B). Comparison of the reference value input to the interface (7) with the machine (2) data obtained as a result of the operation mode (B) is performed in the control unit (5). If it is decided that the machine (2) operates in an unsafe condition according to the comparison results performed in the control unit (5), a warning data is sent quickly from the control unit (5) to the safety module (6) and the machine (2) test is stopped. The safety module (6) may be any of the contactor, relay and protective elements.

In an embodiment of the invention, the machine test mechanism (1) comprises a computer unit (4) which enables the data received by the sensor (3) from physical environment to be converted from analogue into digital. ADC (analogue to digital converter) can be selected to have the required sampling frequency, and it can also be located at the data collection device (10) in the computer unit (4).

In an embodiment of the invention, the machine test mechanism (1) comprises a sensor (3) which is able to measure at least one of vibration, temperature, pressure, distance and rpm data. By using sensors (3) that measure different parameters, instantaneous changes in said parameter values are monitored.

1. A machine test mechanism (1) comprising a machine (2); at least one sensor (3) which is located on the machine (2) and enables data to be received from physical environment; a computer unit (4) which enables data received by the sensor (3) to be collected and stored; a control unit (5) which is located in the computer unit (4), processes data and decides whether the machine (2) operates normally or in an unsafe condition; and a safety module (6) which stops the machine (2) and/or alerts operator in an unsafe condition according to data received from the control unit (5), characterized by a control unit (5) which is adapted to perform the steps of:
applying a mathematical process on the data obtained by the sensor (3), wherein said control unit (5) is further adapted to create a data set (8) by performing random sampling with the data obtained by the sensor (3) within the time period determined by the user (K), create a sub-data set (9) by taking the last sampling data from the data set (8) within the number determined by the user (K), calculates the average of the data set (8) and assigns this as a data set average (801), calculates the average of the sub-data set (9) and assigns this as a sub-data set average (901), obtains a total average value (1001), which is ratio of said data set average (801) to sub-data set average (901), by comparing the data set average (801) to the sub-data set average (901), and use that as a mathematical process application;
obtaining an average value with the data, on which total average value (1001), which is ratio of said data set average (801) to sub-data set average (901) obtained with mathematical process is applied, within the time period determined by a user (K) by the learning mode (A) algorithm that is run automatically when machine start to work by user, and accepting said first ratio value as a machine (2) characteristic;
inputting a reference value by the user (K) via an interface (7) provided in the computer unit (4) according to the machine (2) characteristic value which is obtained as a result of the learning mode (A) in order to initiate machine (2) test process under load, nominal or no load conditions;
after the learning mode (A) algorithm is completed, counting continuously the total average value (1001) obtained with the ratio of the average values with the real time data on the mathematical process application to determine accepting machine (2) data obtained by the operation mode (B);
comparing the reference value input via the interface (7) with the values obtained as a result of the operation mode (B), and deciding whether the machine (2) is operating normally or in an unsafe condition according to the data received from the control unit (5) as a result of the comparison.

2-3. (canceled)

4. The machine test mechanism (1) according to claim 1, characterized by a control unit (5) which uses the total average value (1001) obtained with the mathematical process application to determine machine (2) data obtained by the operation mode (B).

5. (canceled)

6. The machine test mechanism (1) according to claim 1, characterized by a data collection device (10) which is provided in the computer unit (4) and enables the data received by the sensor (3) to be collected.

7. The machine test mechanism (1) according to claim 1, characterized by a memory (11) which is provided in the computer unit (4), and enables data received by the sensor (3) to be stored.

8. The machine test mechanism (1) according to claim 1, characterized by a display (12) which is provided in the computer unit (4), and enables the user (K) to display the interface (7) to which the reference value is input in order to initiate the test process.

9. The machine test mechanism (1) according to claim 1, characterized by a control unit (5) which allows for automatic switch from the learning mode (A) to the operation mode (B) after the time determined by the user (K) is completed.

10. The machine test mechanism (1) according to claim 1, characterized by an interface (7) which accepts the value obtained by the learning mode (A) as a reference value when no data is input as a result of the learning mode (A) by the user (K).

11. The machine test mechanism (1) according to claim 1, characterized by a safety module (6) which provides an aural and/or visual warning in case of an unsafe condition.

12. The machine test mechanism (1) according to claim 1, characterized by a safety module (6) which enables the test to be stopped instantaneously when it is decided that the machine (2) operates in an unsafe condition according to data received from the control unit (5) as a result of comparison of the reference value input to the interface (7) with the values obtained as a result of the operation mode (B).

13. The machine test mechanism (1) according to claim 1, characterized by a computer unit (4) which enables the data received by the sensor (3) from physical environment to be converted from analogue into digital.

14. The machine test mechanism (1) according to claim 1, characterized by a sensor (3) which is able to measure at least one of vibration, temperature, pressure, distance and rpm data.
